(19) United States
(12) Patent Application Publication
(10) Pub. No.: US 2014/0149278 A1
(43) Pub. Date: May 29, 2014

(54) System and Method for Digital Document Management

(71) Applicant: BARCLAYS BANK PLC, London (GB)

(72) Inventors: Barry Windsor, Humberside (GB); John Bowen, South Glamorgan (GB)

(73) Assignee: Barclays Bank PLC, London (GB)

(21) Appl. No.: 13/687,565

(22) Filed: Nov. 28, 2012

(51) Int. Cl. G06Q 40/02

(52) U.S. Cl. CPC G06Q 40/025
USPC 705/38

(57) ABSTRACT

A method and system for processing an application for a financing product for a user in an electronic financing system, by a) authenticating the user by verifying identification and validation responses presented by the user at a computing device; b) transmitting a passcode to the authenticated user; c) providing a digital agreement document associated with the financing product for display to the authenticated user at the computing device; d) verifying a passcode entered by the user to electronically sign the digital agreement document, against the transmitted passcode; and e) if the entered passcode is verified, registering an approved financing product for the user in the electronic financing system.

### FIELD OF THE INVENTION

This invention relates to a digital document management method and system, and particularly to secure processing of an electronic application for a financial loan or credit account, and management of digital documents associated with the application process.

### BACKGROUND OF THE INVENTION

A financial loan or line of credit may be issued to a customer by a bank or other financial institution, subject to identification verification and risk assessment of the customer applying for the loan or credit, and documented acceptance of the terms and conditions of an agreed loan or credit. Typically, applications for such financial loans are paper-based in order for the financial institution to perform the required checks and analysis.

Previously customers shopping online would have had to print up and sign a paper document pack in the home or at the point of acceptance. The document pack is large and complicated, and the loan application process is highly prone to errors. For example, customers often complete the required documentation incorrectly and send the wrong pages back to the loan issuer.

Additionally, as the customer is not face to face with an administrator, a loan issuer typically requires the customer to provide a form of identification by mail, for example, to prove the customer's address, before the agreement is activated and the retail partner is advised to dispatch the goods. This gives rise to a risk for the customer as they have to send official and important paper documents in the public postal mail system. Invariably, customers send improper documents or copies of documents which are unacceptable. These errors increase the overall processing time and costs, and impact the delayed fulfillment of the customer order significantly.

There are additional problems with this typical route. Because there is no face to face interaction via this route, fraudsters often apply via this method. To satisfy the loan issuer's identification requirement, fraudsters send supporting, fraudulent identification (“ID”). This fraudulent ID is often of very high quality and difficult for back office process owners to spot thus increasing process time and causing additional risk exposure to the loan issuer, customers and clients.

What is needed is a more efficient and secure system for processing online applications for financial loans and credit.

### SUMMARY OF THE INVENTION

According to one aspect of the present invention, there is provided a method and system for processing an application for a financing product for a user in an electronic financing system. The method is achieved by a) authenticating the user by verifying identification and validation responses presented by the user at a computing device; b) transmitting a passcode to the authenticated user; c) providing a digital agreement document associated with the financing product for display to the authenticated user at the computing device; d) verifying a passcode entered by the user to electronically sign the digital agreement document, against the transmitted passcode; and e) if the entered passcode is verified, registering an approved financing product for the user in the electronic financing system.

In a further aspect of the present invention, authentication of the user in the application process is performed by receiving information presented by the user at a computing terminal; retrieving secured details associated with the user from a bureau database; generating at least one user validation question based on the retrieved secure details; receiving a response to the at least one generated user validation question presented by the user at the computing terminal; and verifying the received response against the retrieved secure details to authenticate the user.

In one embodiment, the process of verifying the identity of a customer applying for a loan relies on the inherent security provided by utilizing customer data retrieved from a bureau database, and hence known only to the customer, together with the secure transmission of the loan application documents as a digital document pack to the customer's terminal or device.

According to another aspect of the invention, there is provided a method and system for securely receiving electronically signed digital documentation indicative of acceptance of terms and conditions associated with an issued financing product.

In one embodiment, the application process is conducted through a web browser interface of the customer terminal or device. In another embodiment, software is loaded on the customer's device to enable the customer to both apply for and activate an approved loan from their device. This process is achieved using an authentication token transmitted to the customer via a separate communication channel.

In yet a further aspect of the present invention there is provided a computing device, an online loan application system, and associated computer programs arranged to carry out the above method.

### BRIEF DESCRIPTION OF THE DRAWINGS

There now follows, by way of example only, a detailed description of embodiments of the present invention, with references to the figures identified below.

FIG. 1 is a block diagram showing the main components of a financing system according to an embodiment of the invention;

FIG. 2 is a flow diagram of a loan application process in an embodiment of the invention; and

FIG. 3 is a diagram of an example of a computer system on which one or more of the functions of the embodiment may be implemented.

### DETAILED DESCRIPTION OF EMBODIMENTS OF THE INVENTION

### Technical Architecture

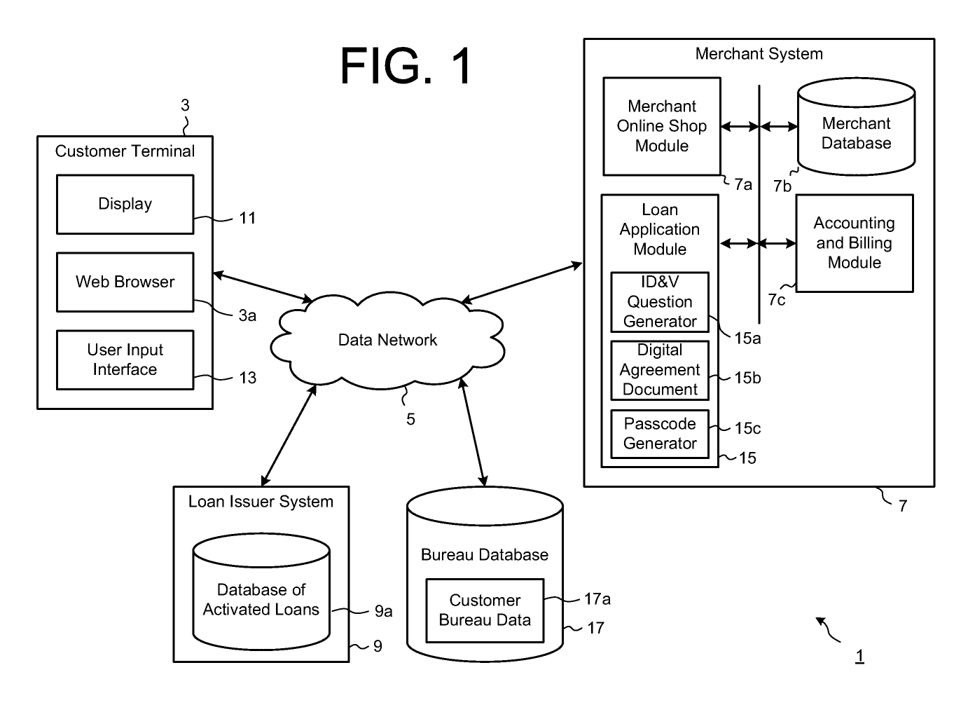

Referring to FIG. 1, a financing system 1 according to an embodiment of the invention includes a customer computer terminal 3 communicating over a data network 5 with a merchant system 7 and a loan issuer system 9. The customer computer terminal 3 is of a type that is known to those skilled in the art, such as a personal computer, laptop, computing terminal or the like, or a mobile smartphone such as an iPhone™, Blackberry™ or Android™ smartphone. In this embodiment, the customer computer terminal 3 runs a web browser application 3a and provides for user interaction through a display 11 and a user input interface 13 such as a touch screen, touch pad, mouse, stylus or the like. In alternate embodiments, the computer terminal 3 runs a dedicated financing application issued by the merchant system 7 or the loan issuer system 9. It will be appreciated that the customer computer terminal 3 is merely an example of a potentially large number of computing devices operable within the system.

The data network 5 may be any suitable data communication network such as a mobile network, wireless network, a local- or wide-area network including a corporate intranet or the Internet, for example. The customer computer terminal 3 communicates with the merchant system 7 via the data network 5 using communication protocols of a type that are known to those skilled in the art of data networks, for example TCP/IP, GPRS, EDGE or 3G protocols, and need not be described further.

The merchant system 7 includes a merchant online shop module (or system) 7a and a merchant database 7b that provide a merchant website for display by the customer computer terminal 3, for example, through the web browser application 3a or any other suitable application. The merchant database 7b can also store data associated with customers registered with the merchant, such as names, contact details, addresses, payment card or account details, etc. An accounting and billing module (or system) 7c is also provided to handle the associated payment transactions from sender to recipient funding accounts. Such retailer web sites hosted on a web server are well known to those skilled in the art and need not be described further. In this embodiment, the merchant system 7 also manages a loan application module (or system) 15 providing an online loan application that is transmitted to the customer computer terminal 3. The online loan application can be an online web-based form of a type that is known to those skilled in the art and need not be described further.

The loan application module 15 is provided by the associated loan issuer system 9. The loan application module 15 processes user input received from the customer computer terminal 3 as the user is completing the online application, including information such as legal name, home address, date of birth, e-mail address and the like. The loan application module 15 authenticates the user based on received user responses with an integrated identification process using an Identification and Verification (ID&V) question generator 15a. In one embodiment, the ID&V question generator 15a generates questions based on customer details, that is, customer bureau data, 17a associated with the user that are retrieved from an external bureau database 17. The bureau database 17 securely stores customer bureau details 17a, such as current banking and lending information associated with the individual customer, and voters roll validation information for the customer which will include present and past residential addresses of record.

It will be appreciated that these examples are provided merely to illustrate the types of customer bureau data 17a that can be provided to the system, and other types of bureau data are available that relate to information which is inherently known to the customer but not by a potential fraudster. The bureau database 17 can be securely hosted by a third party credit bureau that collects and collates personal information, financial data, and alternative data on individuals from a variety of data sources with which the bureaus have a relationship.

The loan application module 15 also manages transmission of a digital agreement document 15b to the customer computer terminal 3, the digital agreement document 15b including the terms and conditions that are associated with the loan. The loan application module 15 also manages transmission of a passcode generated by a passcode generator 15c, for example by an e-mail to the customer. The received passcode is used by the customer to electronically sign the digital agreement document 15b at the customer computer terminal 3, to immediately indicate acceptance of the stated terms and conditions associated with the loan. The loan application module 15 receives the electronically signed digital agreement document 15b and can then notify the loan issuer system 9 of the approved and agreed loan via the data network 5. The loan issuer system 9 stores data associated with all approved and agreed loans in a database of activated loans 9a.

The merchant online shop module 7a, merchant database 7b, loan application system 15 and accounting and billing module (or system) 7c are in operative communication with each other via, for example, a bus or any other subsystem that may transfer data between components and modules in the merchant system 7.

### Loan Application Processing and Digital Agreement Document Handling

An example of a process of processing an application for a financial product, such as a monetary loan or credit based funding account, for a customer will now be described, to illustrate the technical advantage of the financing system embodiment described above. Although the example is given in the context of applying for a financial loan issued by a loan issuer, it will be appreciated that the loan application module 15 can be adapted to process an online application for any other form of financial product, such as a credit card account or the like.

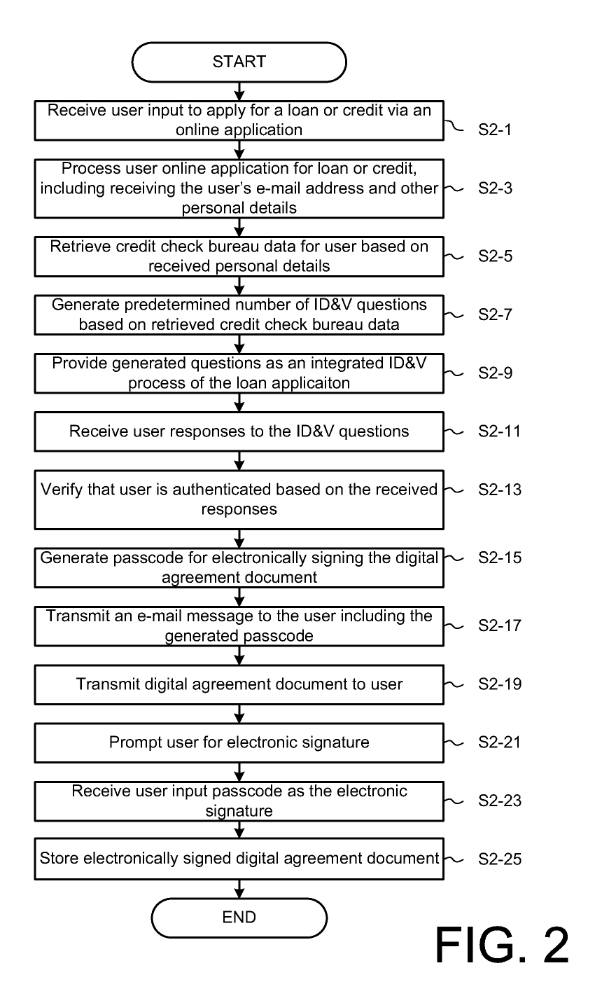

FIG. 2 shows a flow diagram of the process of processing an online application for a loan and handling of the digital agreement document in a secure and efficient manner. For example, a customer at a merchant retailer online web site may be prompted to apply for financing to complete a purchase by clicking on a web link at the check-out stage of the online purchase transaction. in response to the customer providing user input to start the online loan application process, the merchant online shop module 7a passes control to the loan application module 15 to provide the online application for a financial product to the customer computer terminal 3.

The loan application process begins at S2-1 where the loan application module 15 receives user input to apply for a loan via the online application. In response, the loan application module 15 processes a new online loan application for the customer at step S2-3, for example, by providing an online form through a sequence of web pages to prompt the user to input personal information such as legal name, home address, date of birth, e-mail address, and the like. The user input information is transmitted back to loan application module 15. In one embodiment, the customer data, stored in the merchant database 7b, is provided by the merchant online shop module 7a to the loan application module 15 to populate respective fields of the online application. In this way, the customer can complete the online application by providing any missing data or information.

As mentioned above, a user identification and verification (ID&V) process is integrated with the loan application process. The integrated user ID&V process begins at step S2-5 where the loan application module 15 communicates with the bureau database 17 to retrieve bureau data 17a associated with the customer. At step S2-7, the ID&V question generator 15a uses the retrieved bureau customer data 17a to automatically generate a predefined number of questions for automated identification and verification of the customer. The number of questions that are generated for ID&V of a particular customer can depend on risk factors determined by the loan application module 15. As an example, five multiple choice questions are generated by the ID&V question generator 15a for a typical customer that raises no high risk factors.

The questions are based on the bureau customer data 17a retrieved from the bureau database 17, which can be transmitted in a predefined format to identify the available information for that customer, such as his or her current banking and lending information, and present and past residential addresses of record. The ID&V question generator 15a stores a database of template questions associated with different types of information retrieved from the bureau database 17, and the automatically generated ID&V questions are preferably of a form such as “When did you move into your current address?” or “You have a direct debit of 200 pounds leaving your account each month. Who is this to?” At step S2-9, the loan application module 15 provides the generated questions as the integrated ID&V process for the online loan application.

It will be appreciated that the loan application module 15 may carry out further steps of assessing whether a loan can be issued to the customer, as known to those skilled in the art and need not be described further. It will also be appreciated that when the loan application module 15 is unable to retrieve customer data from the bureau database 17, or if insufficient customer data is available from the bureau database 17 for the ID&V question generator 15a to generate a required number of questions, then the loan application module 15 is configured to decline the online loan application and notify the customer accordingly. Alternatively, the loan application module 15 can proceed with the loan application in a conventional manner, for example transmitting the digital agreement documents 15b to the customer terminal with instructions to print the documents, physically sign the documents, and mail the web-signed documents back to the loan issuer.

Returning back to step S2-11 the loan application module 15 receives the user responses to the automatically generated ID&V questions and verifies that the customer's identity is authenticated by comparing the received responses to the customer data from the bureau database 17. The loan application module 15 then provides an “Accept Decision” web page for display to the customer indicating that the loan application has been accepted and approved, and prompting the customer to download and view a digital agreement document 15b associated with the approved loan.

After verifying the customer's identity, the passcode generator 15c generates a passcode at step S2-15 that will be used by the customer to electronically sign the digital agreement document 15b associated with the loan. The generated passcode is preferably a numeric code of a predefined length, for example, a six digit numeric passcode. Alternatively, any other form of passcode can be generated, such as a numeric, alphabetic, alphanumeric or non-alphanumeric symbols of predefined or varying lengths. At step S2-17, the loan application module 15 transmits a confirmation message to the customer, for example as an e-mail to the customer's email address. The e-mail confirmation message includes the passcode that is generated by the passcode generator 15c.

At step S2-19, the loan application module 15 transmits the digital agreement document 15b to the customer computer terminal 3, for example, in response to user input when prompted by the “Accept Decision” web page. The digital agreement document 15b is generated by the loan application module 15 to include details of the accepted loan and the associated terms and conditions that the customer must acknowledge before the loan is actually issued. The loan application module 15 can provide the digital agreement document 15b in any form, such as a sequence of document pages for display by the browser application 3a of the computer terminal 3, or as a single digital document that is downloaded to the computer terminal 3 for viewing in a document reader application.

At step S2-21, the customer is prompted at the computer terminal 3 to input the received passcode as an electronic signature to indicate that he or she has reviewed the digital agreement document 15b and is accepting the stated terms and conditions. The user input passcode is received by the loan application module 15 at step S2-23 as the electronic signature from the customer. In response, the loan application module 15 stores the customer's digital agreement document 15b as a non-editable electronically signed digital document, for example, by adding the date of receiving the passcode as the electronic signature, text indicating that the document was electronically signed, and information identifying the customer computer terminal 3 from which the electronic signature was received, such as the IP address of the customer computer terminal 3. At step S2-25, the loan application module 15 transmits the electronically signed digital agreement document 15b to the loan issuer system 9 for storage in the database of activated loans 9a. The online application can also provide a final web page to the customer to indicate that the electronic signature was accepted and presenting a link for the customer to download a copy of the non-editable electronically signed digital agreement document.

### Advantages

A number of advantages will be understood from the above description of the embodiments of the present invention.

In particular, the use of a passcode to electronically sign the digital agreement documents is advantageous, as it allows the loan issuer to complete a paperless application process via a client web-store from wing to wing, and enables assured acknowledgement and delivery of signed agreement documentation to be instant.

Additionally, the online loan application process includes an integrated challenge question based identification and verification process that efficiently determines that a customer is authenticated before allowing the customer to progress to e-signing of their agreement with no need for paper copies to be posted or a web signature to be captured.

Moreover, as the new identification and verification process generates ID&V questions for the customer which are gleaned from the customer's current bureau, a loan issuer is assured that the customer is authenticated (i.e. applicant is who they say they are) when the customer achieves an acceptable pass rate. This integrated identification and verification process negates the requirement for supporting ID and reduces the chance of fraud attacks from online applications for financial products.

### Computer Systems

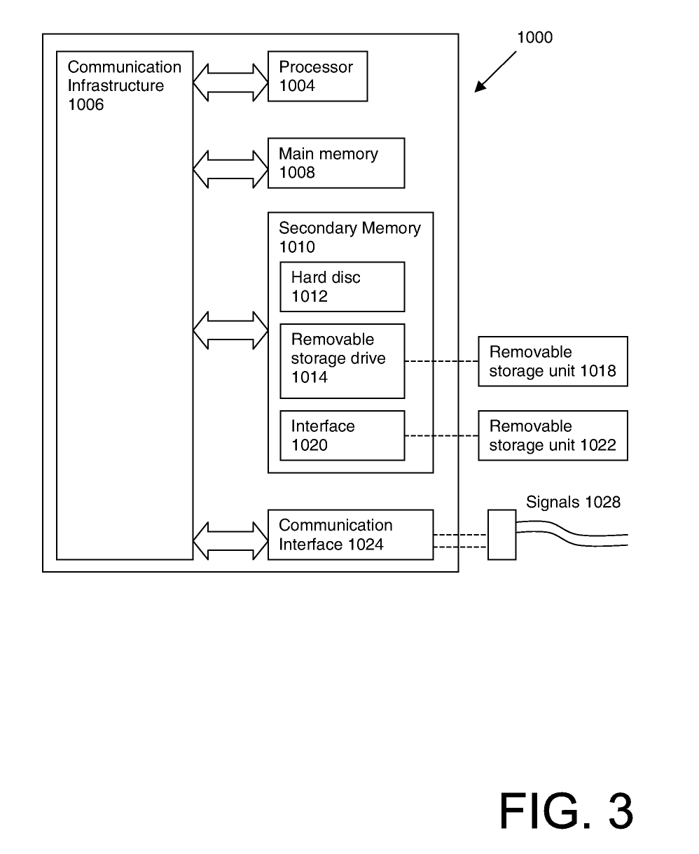

The entities described herein, such as the merchant system and the loan application module, and their respective constituent modules and components, may be implemented by computer systems such as a computer system 1000 as shown in FIG. 3. Embodiments of the present invention may be implemented as programmable code for execution by such computer systems 1000. After reading this description, it will become apparent to a person skilled in the art how to implement the invention using other computer systems and/or computer architectures.

The computer system 1000 includes one or more processors, such as a processor 1004. The processor 1004 may be any type of processor, including but not limited to a special purpose or a general-purpose digital signal processor. The processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

The computer system 1000 also includes a main memory 1008, preferably random access memory (RAM), and may also include a secondary memory 610. The secondary memory 1010 includes, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well-known manner. The removable storage unit 1018 represents a floppy disk, magnetic tape, optical disk, etc., which is read by and written to by removable storage drive 1014. As will be appreciated, the removable storage unit 618 includes a computer usable storage medium having stored therein computer software and/or data.

In alternative implementations, the secondary memory 1010 preferably includes other similar means for allowing computer programs or other instructions to be loaded into the computer system 1000. Such means include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from the removable storage unit 1022 to the computer system 1000. Alternatively, the program may be executed and/or the data accessed from the removable storage unit 1022, using the processor 1004 of the computer system 1000.

The computer system 1000 also includes a communication interface 1024. The communication interface 1024 allows software and data to be transferred between the computer system 1000 and external devices. Examples of the communication interface 1024 may include a modem, a network interface (such as an Ethernet card), a communication port, a Personal Computer Memory Card International Association (PCMCIA) slot and card, etc. Software and data transferred via the communication interface 1024 are in the form of signals 1028, which may be electronic, electromagnetic, optical, or other signals capable of being received by the communication interface 1024. These signals 1028 are provided to the communication interface 1024 via a communication path 1026. The communication path 1026 carries signals 1028 and may be implemented using wire or cable, fibre optics, a phone line, a wireless link, a cellular phone link, a radio frequency link, or any other suitable communication channel. For instance, the communication path 1026 may be implemented using a combination of channels.

The terms “computer program medium” and “computer usable medium” are used generally to refer to media such as removable storage drive 1014, a hard disk installed in the hard disk drive 1012, and the signals 1028. These computer program products are means for providing software to the computer system 1000. However, these terms may also include signals (such as electrical, optical or electromagnetic signals) that embody the computer program disclosed herein.

Computer programs (also called computer control logic) are stored in the main memory 1008 and/or the secondary memory 1010. Computer programs may also be received via the communication interface 1024. Such computer programs, when executed, enable the computer system 1000 to implement embodiments of the present invention as discussed herein. Accordingly, such computer programs represent controllers of the computer system 1000. Where the embodiment is implemented using software, the software may be stored in a computer program product and loaded into the computer system 1000 using the removable storage drive 1014, the hard disk drive 1012, or the communication interface 1024, to provide some examples.

Alternative embodiments may be implemented as control logic in hardware, firmware, or software or any combination thereof.

### Alternative Embodiments

The above embodiments are described by way of example, and alternative embodiments may become apparent to the skilled person on reading the above description.

For example, in the embodiment described above, the customer is prompted to provide the received the passcode as an electronic signature to indicate that he or she has reviewed the digital agreement document and is accepting the stated terms and conditions. As those skilled in the art will appreciate, the online application may provide an alternative option for the customer to instead download, print, sign and mail a paper copy of the agreement document to the loan issuer, to complete the loan application process in the traditional, less efficient, manner.

In a further alternative embodiment, after the customer has been authenticated by the integrated challenge question identification and verification process, the customer may be prompted to digitally sign a received digital agreement document using an input interface of the customer terminal that supports direct input of the customer's signature, for example using his or her finger or a stylus.

In the embodiment above, a predefined number of ID&V questions are automatically generated based on customer details retrieved from a bureau database, and the customer is authenticated after verifying that he or she has responded with correct answers to all of the generated questions. As those skilled in the art will appreciate, due to the automated nature of the question generation, the loan application module could instead be configured to verify a customer's identity when a predefined or threshold number of the ID&V questions have been answered correctly. For example, the system can determine that a customer is authenticated when he or she answers a minimum of three out of five ID&V questions correct and thus allow the customer to progress to e-signing of their digital agreement document.

Although not illustrated, it will be appreciated that when the loan application module is unable to verify the identity of the customer, for example, if the customer does not correctly answer all of the generated ID&V questions, then the customer is not authenticated to the system and the loan application will be declined. Additionally, even after the customer is authenticated by the integrated ID&V challenge question process, the loan application module may determine that the customer is not eligible for a loan for other reasons. A decline message can be transmitted to the customer terminal, and the message can include the reason for the decline decision.

In the embodiment described above, the loan application module is provided by the loan issuer system and managed by the merchant system. As those skilled in the art will appreciate, the loan issuer system may instead host and manage a loan application module, and communicate with the merchant system to handle requests for new financial products.

It will also be appreciated that some of the process steps described in the embodiment above may proceed in various orders and that the particular order shown in FIG. 2 is for illustrative purposes according to one exemplary embodiment of said steps. For example, the online loan application module may be arranged to generate and transmit a passcode to the customer by e-mail at an earlier stage of the application process.

As a further modification, the loan application module may instead be configured to pass the received user details from the online application to the loan issuer system, and the loan issuer system can instead verify the identity of the applicant customer and determine whether he or she is eligible for the financial product subsequently register and activate the approved financial product.

What is claimed is:

1. A computer-implemented method of processing an application for a financing product for a user in an electronic financing system, the method comprising the steps of:
a) authenticating the user by verifying identification and validation responses presented by the user at a computing device, the user becoming an authenticated user upon verification of the identification and validation responses;
b) transmitting a passcode to an authenticated user;
c) providing a digital agreement document associated with the financing product for display to the authenticated user at the computing device;
d) verifying a passcode entered by the authenticated user to electronically sign the digital agreement document, against a transmitted passcode; and
e) if an entered passcode is verified, registering an approved financing product for the authenticated user in the electronic financing system.

2. The method of claim 1, wherein authenticating the user comprises the steps of:
a1) receiving information presented by the user at a computing terminal to complete the application for the financing product;
a2) retrieving additional details associated with the user from a bureau database;
a3) generating at least one user validation question based on the additional details that are retrieved;
a4) receiving a response to the at least one generated user validation question presented by the user at the computing terminal; and
a5) verifying the response received against the additional details that are retrieved to authenticate the user.

3. The method of claim 2, wherein the additional details that are retrieved are not transmitted to the user at the computing terminal.

4. The method of claim 2, wherein a number of generated user validation questions is based on a determined level of security associated with the user.

5. The method of claim 1, wherein the passcode is transmitted to the authenticated user by e-mail.

6. The method of claim 1, wherein the passcode is entered by the authenticated user at the computing device to electronically sign the digital agreement document.

7. The method of claim 1, wherein the passcode comprises numeric, alphabetic, alphanumeric or non-alphanumeric symbols.

8. The method of claim 1, wherein the financing product is a monetary loan or a credit based payment account.

9. The method of claim 1, wherein the digital agreement document comprises terms and conditions associated with the financing product.

10. The method of claim 9, wherein the user electronically signs the digital document to indicate acceptance of the terms and conditions.

11. A system for processing an application for a financing product for a user, comprising:
a) an authenticator that authenticates the user by verifying identification and validation responses presented by the user at a computing device, the user becoming an authenticated user upon verification of the identification and validation responses;
b) a passcode transmitter that transmits a passcode to the authenticated user;
c) a digital document provider that provides a digital agreement document associated with the financing product for display to the authenticated user at the computing device;
d) a passcode verifier that verifies a passcode entered by the authenticated user to electronically sign the digital agreement document, against the transmitted passcode; and
e) an approver that registers an approved financing product for the authenticated user in the electronic financing system when the entered passcode is verified.

12. The system of claim 11, wherein the authenticator is operable to authenticate the user by:
a1) receiving information presented by the user at a computing terminal;
a2) retrieving secured details associated with the user from a bureau database;
a3) generating at least one user validation question based on the retrieved secured details;
a4) receiving a response to the at least one generated user validation question presented by the user at the computing terminal; and
a5) verifying the received response against the retrieved secured details to authenticate the user.

13. A non-transitory computer-readable medium comprising computer-executable instructions, that when executed perform the method comprising the steps of:
a) authenticating the user by verifying identification and validation responses presented by the user at a computing device, the user becoming an authenticated user upon verification of the identification and validation responses;
b) transmitting a passcode to the authenticated user;
c) providing a digital agreement document associated with the financing product for display to the authenticated user at the computing device;
d) verifying a passcode entered by the authenticated user to electronically sign the digital agreement document, against the transmitted passcode; and
e) if an entered passcode is verified, registering an approved financing product for the authenticated user in the electronic financing system.
